(19) United States
(12) Patent Application Publication
(10) Pub. No.: US 2026/0289247 A1
(43) Pub. Date: Sep. 24, 2026

(54) LOOP FILTER USING HETEROGENOUSLY QUANTIZED DEPTHWISE SEPARABLECONVOLUTIONAL NEURAL NETWORK

(71) Applicant: Google LLC, Mountain View, CA (US)

(72) Inventors: Akshaya Purohit, Santa Clara, CA (US); Shan Li, Fremont, CA (US); In Suk Chong, Mountain View, CA (US); Urvang Joshi, Mountain View, CA (US); Debargha Mukherjee, Cupertino, CA (US)

(21) Appl. No.: 19/570,745

(22) Filed: Mar. 18, 2026

Related U.S. Application Data
(60) Provisional application No. 63/774,555, filed on Mar. 19, 2025.

(51) Int. Cl. G06N 3/0464; G06N 3/0495

(52) U.S. Cl. CPC G06N 3/0464; G06N 3/0495

(57) ABSTRACT

Disclosed are methods, devices, and computer-readable medium for loop filtering using heterogeneously quantized depthwise separable convolutional neural networks. A method includes producing a filtered block of pixels by applying a heterogeneously quantized depthwise separable convolutional neural network (HQDSCNN) to a decoded block of pixels. The HQDSCNN includes a plurality of layers each having components represented using a respective number of bits pre-determined according to a heterogeneous quantization process including identifying a set of key components, setting a minimum number of bits for representing non-key components, and iteratively evaluating candidate numbers of bits for representing components of the set of key components.

### CROSS-REFERENCE TO RELATED APPLICATION(S)

This disclosure claims the benefit of U.S. Provisional Patent Application No. 63/774,555 filed Mar. 19, 2025, the disclosure of which is incorporated by reference herein in its entirety.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video data transmitted over communications channels having limited bandwidth.

### SUMMARY

This application relates to encoding and decoding of image data, video stream data, or both for transmission, storage, or both. Disclosed herein are aspects of systems, methods, and apparatuses for loop filtering using heterogeneously quantized depthwise separable convolutional neural networks.

In an aspect of the disclosure, a method is provided. The method includes producing a filtered block of pixels by applying a heterogeneously quantized depthwise separable convolutional neural network (HQDSCNN) to a decoded block of pixels, wherein the HQDSCNN includes a plurality of layers each having components represented using a respective number of bits pre-determined according to a heterogeneous quantization process including identifying a set of key components, setting a minimum number of bits for representing non-key components, and iteratively evaluating candidate numbers of bits for representing components of the set of key components.

In another aspect of the disclosure, a device is provided. The device includes at least one processor configured to produce a filtered block of pixels by applying a heterogeneously quantized depthwise separable convolutional neural network (HQDSCNN) to a decoded block of pixels, wherein the HQDSCNN includes a plurality of layers each having components represented using a respective number of bits pre-determined according to a heterogeneous quantization process including identifying a set of key components, setting a minimum number of bits for representing non-key components, and iteratively evaluating candidate numbers of bits for representing components of the set of key components.

In another aspect of the disclosure, a non-transitory computer-readable medium is provided. The non-transitory computer-readable medium stores an encoded bitstream comprising video data, wherein the encoded bitstream is decodable by a decoding apparatus by performing operations comprising producing a decoded block of pixels from the video data, and producing a filtered block of pixels by applying a heterogeneously quantized depthwise separable convolutional neural network (HQDSCNN) to the decoded block of pixels, wherein the HQDSCNN includes a plurality of layers each having components represented using a respective number of bits pre-determined according to a heterogeneous quantization process including identifying a set of key components, setting a minimum number of bits for representing non-key components, and iteratively evaluating candidate numbers of bits for representing components of the set of key components.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a block diagram illustrating an architecture for using convolutional neural networks to filter a video frame.

FIG. 8 is a block diagram illustrating a depthwise separable convolutional neural network architecture.

FIG. 9 is a block diagram illustrating a block in the depthwise separable convolutional neural network architecture.

FIG. 10 is a flow diagram of an example technique for heterogeneously quantizing a depthwise separable convolutional neural network.

FIG. 11 is a flow diagram of an example technique for filtering pixels using a heterogeneously quantized depthwise separable convolutional neural network.

### DETAILED DESCRIPTION

Compression schemes related to coding video streams may include breaking images into blocks and generating a digital video output bitstream using one or more techniques to limit the information included in the output. A received bitstream can be decoded to re-create the blocks and the source images from the limited information. Encoding a video stream, or a portion thereof, such as a frame or a block, can include using temporal or spatial similarities in the video stream to improve coding efficiency. For example, a current block of a video stream may be encoded based on identifying a difference (residual) between a prediction based on previously decoded pixel values and those in the current block. In this way, the residual and parameters used to generate it need be added to the bitstream instead of including the entirety of the current block. This technique may be referred to as inter or intra prediction (depending on where the previously decoded pixel values are obtained from). The resulting residual may be encoded using transformation and quantization techniques which convert the residual data from the spatial to the temporal domain and then reduce the data transmitted by reducing the degree of precision at which the resulting transform coefficients are transmitted.

Quantization can result in artifacts, such as blocking artifacts, when the encoded video stream is decoded. For example, quantization can result in visibly noticeable discontinuities between blocks due to the reduced precision at which the residual is stored. Loop filtering may be utilized to remove such discontinuities, and other artifacts. Loop filtering can include applying one or more techniques, such as applying one dimensional filters across block boundaries, two dimensional filters across all or part of a video frame, or combinations thereof. In some video encoding and decoding implementations, a machine learning approach may be used instead or in addition to other techniques to filter pixels of a video frame to remove or reduce artifacts identified according to weights learned based on a training set of known artifacts. For example, a convolutional neural network (CNN) based filter may be utilized. An implementation of such a filter may, for example, utilize an encoder-decoder based architecture with multiple layers.

Utilizing a CNN based filter to filter decoded pixels may prove challenging due to the computational and memory complexity of such models, which may make the use of such techniques impracticable for commercially viable hardware decoders due to the usage of large amounts of chip surface area. One way to reduce complexity is to quantize parameters of the filter. However, homogeneously quantizing the parameters can negatively impact the performance of the filter. While heterogeneous quantization allows different layers of a neural network to use different bit-widths, determining the optimal bit-width for each layer in a complex architecture is computationally prohibitive. For example, Quantization-Aware Training (QAT) requires computationally expensive retraining of the model.

Implementations of this disclosure solve these technical problems by introducing a constrained, iterative Post-Training Quantization (PTQ) search methodology that reduces the search space while reducing hardware complexity (e.g., reducing logic gate count) for the resulting heterogenous model. For example, implementations of this disclosure utilize a heterogeneously quantized depthwise separable convolutional neural network (HQDSCNN). The HQDSCNN is quantized by first training a non quantized depthwise separable convolutional neural network (NQDSCNN). Key components in the NQDSCNN are identified (for example by testing a reduction of bits on a layer-by-layer basis to identify which portions of the NQDSCNN have a greater impact on performance). Non-key components may be represented by a minimum number of bits (e.g., 10 bits). Key components may be iteratively tested to identify a number of bits usable for representing each key component based on criteria such as a targeted total number of bits used for the HQDSCNN and performance metrics for the HQDSCNN after quantization. In some implementations, non-key components may be revisited depending on the measured performance. Once completed, the identified number of bits for the components of the NQDSCNN are used for quantization to produce a HQDSCNN where components are heterogeneously represented using different numbers of bits according to the identified numbers of bits per component. The produced HQDSCNN may be standardized as a part of a video coding standard. For example, the produced HQDSCNN may be pre-defined as a part of the video coding standard and may be implemented in encoders and decoders compliant with the video coding standard.

Implementations of this disclosure perform loop filtering using heterogeneously quantized depthwise separable convolutional neural networks quantized according to heterogeneous quantization techniques described herein.

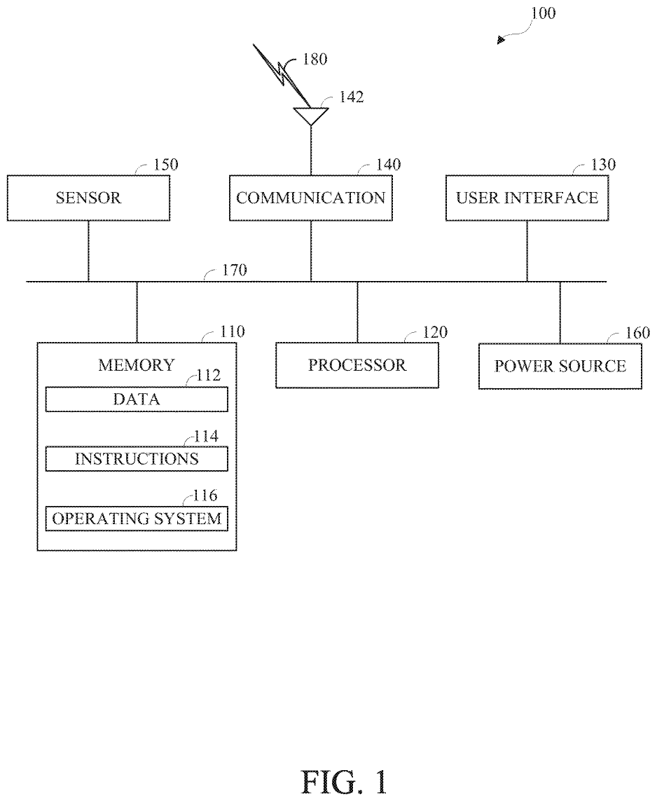

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input video data, encoded video data, decoded video data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

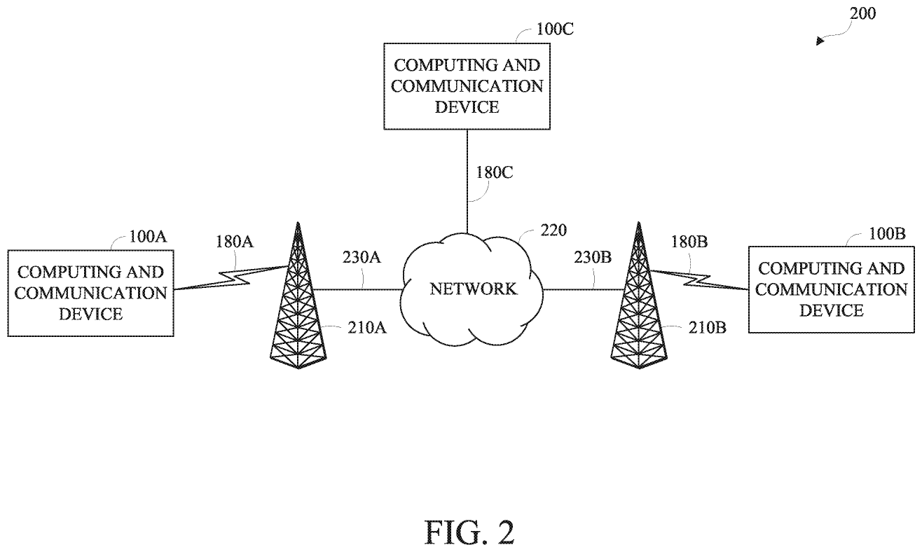

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof video data and one or both of the computing and communication device 100A and the computing and communication device 100B may receive, decode, process, store, present, or a combination thereof the video data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communication devices, networks, and access points.

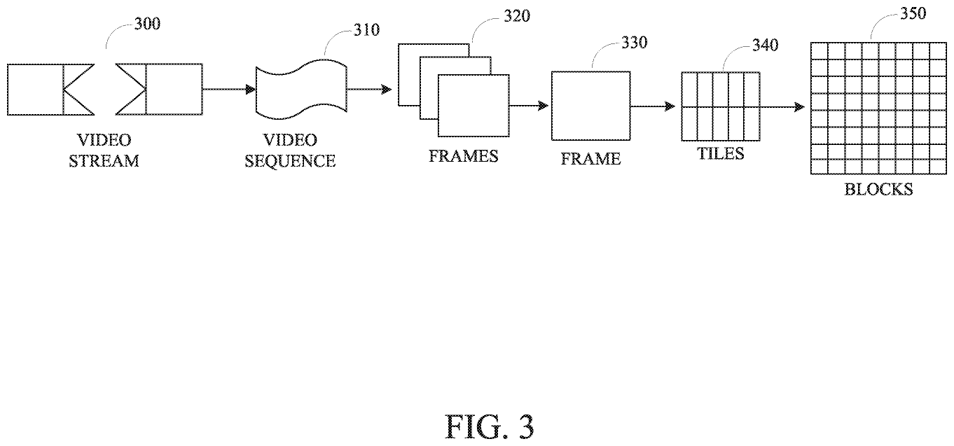

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

A frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. A tile 340 may be a rectangular region of the frame that can be coded independently. Tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

Some implementations may include additional or fewer components than described with respect to FIG. 3. For example, some implementations may not utilize tiles. For example, some implementations may utilize slices or some other intermediate partitioning of a frame instead of tiles. For example, some implementations may utilize different block structures. For example, some implementations may utilize variable block sizes. For example, some implementations may utilize a hierarchical block structure with two or more levels of blocks with different sizes (e.g., in a quad-tree type structure) where different information is coded at different block levels. For example, different block structures may be utilized for different purposes, such as for prediction, transformation, and filtering.

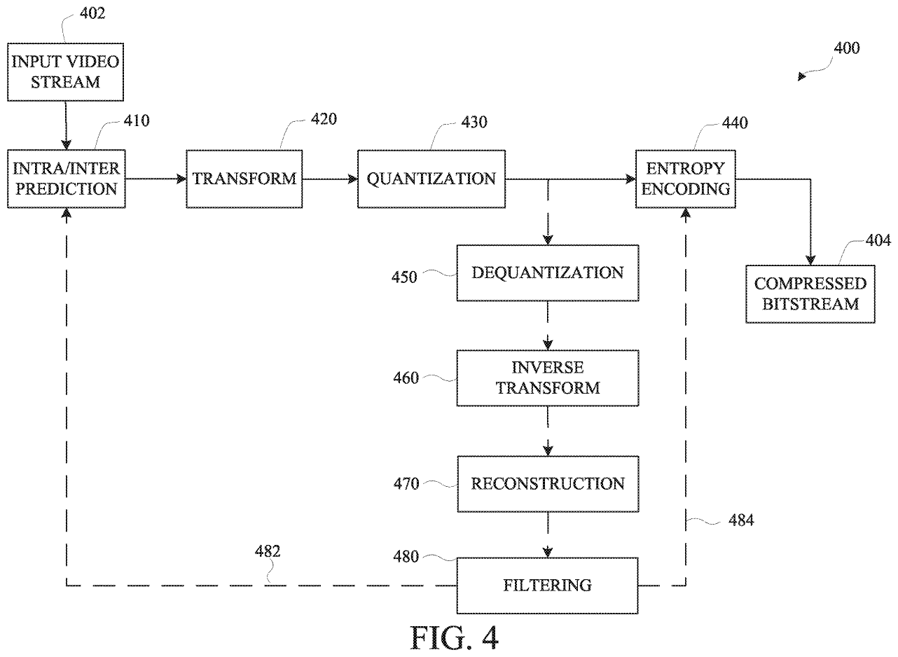

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame. The motion vector may be generated at a sub-pixel precision. In such a case, interpolation may be utilized to approximate the pixels of the prediction block based on decoded pixels in the reference frame.

The intra/inter prediction unit 410 may subtract the prediction block from the current block (raw block) to produce a residual block. The transform unit 420 may perform a block-based transform, which may include transforming a block of residual pixels into a transform block of transform coefficients in, for example, the frequency domain. The block of pixels used to create a transform block may be the same or different than the blocks used to generate the prediction and residual blocks. For example, a transform block may be a subdivision of a residual block or residual values in a frame may be partitioned using a different block partitioning scheme altogether as compared to the blocks used to produce the residual values. Examples of block-based transforms include the Karhunen-Loeve Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete quantized values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the transform block, which may include the type of prediction used, motion vectors, and quantizer values, can be output to the compressed bitstream 404. The compressed bitstream 404 can be formatted using various techniques, such as run-length encoding (RLE) and zero-run coding.

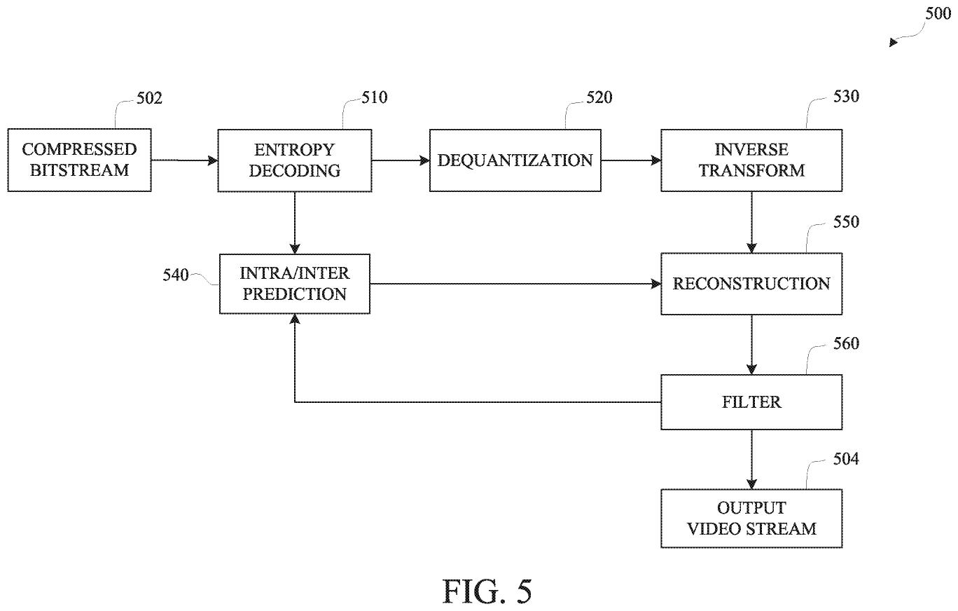

The reconstruction path can be used to maintain prediction synchronization between the encoder 400 and a corresponding decoder, such as the decoder 500 shown in FIG. 5. The reconstruction path may be similar to the decoding process discussed below and may produce an output equivalent to that produced by the decoding process to enable prediction at both the encoder and the decoder to produce the same results. The reconstruction process may include decoding the encoded frame, or a portion thereof, which may include decoding an encoded transform block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. In the event that different block sizes or partitioning schemes are used for prediction and transform, decoded residual values from multiple transform blocks may be utilized when reconstructing a decoded block of pixels using a prediction block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. Depending on the implementation, filtering may be applied on a basis other than a block basis. The reconstructed block may be stored or otherwise made accessible as a reconstructed block, which may be a portion of a reference frame, for encoding another portion of a current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, in some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the filtering unit 560.

A video coding standard may specify the requirements to produce a compliant decoder. Such a standard may not specify how to make a video encoder or may provide only certain requirements as to what must be included in a compliant encoder. Instead, an encoder is compliant if it produces a video bitstream that is capable of being decoded by a compliant video decoder. Accordingly, certain tools are implemented to produce the same results in both the encoder and decoder, such as contexts for entropy coding and decoding an end-of-block position of a transform block.

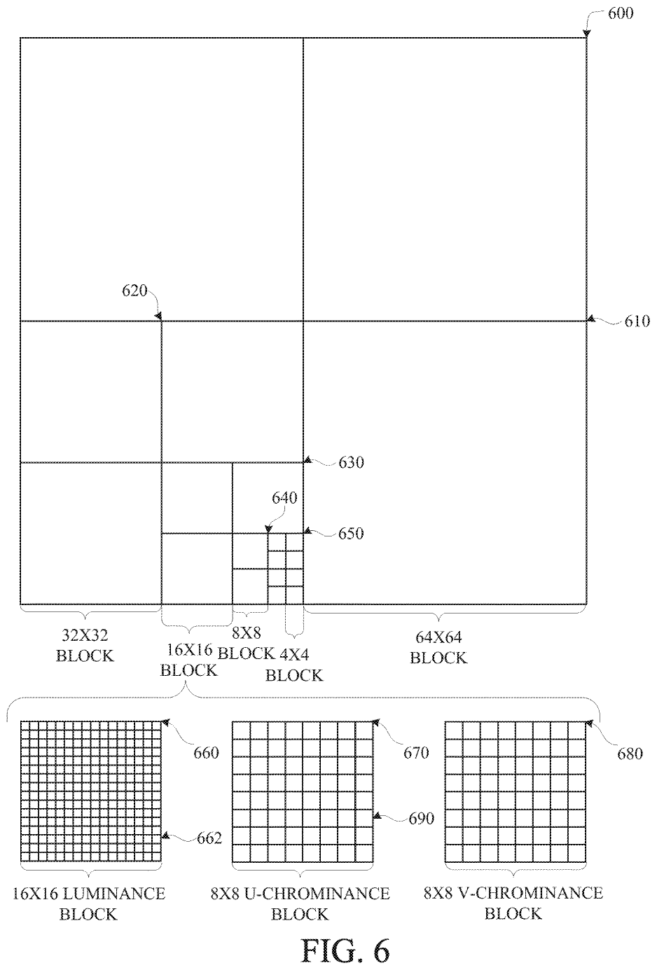

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as fry. Similarly, a pixel of the search area of the reference frame may be indicated based on location using Cartesian coordinates as r_{x,y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding using transform partitioning may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding using transform partitioning may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

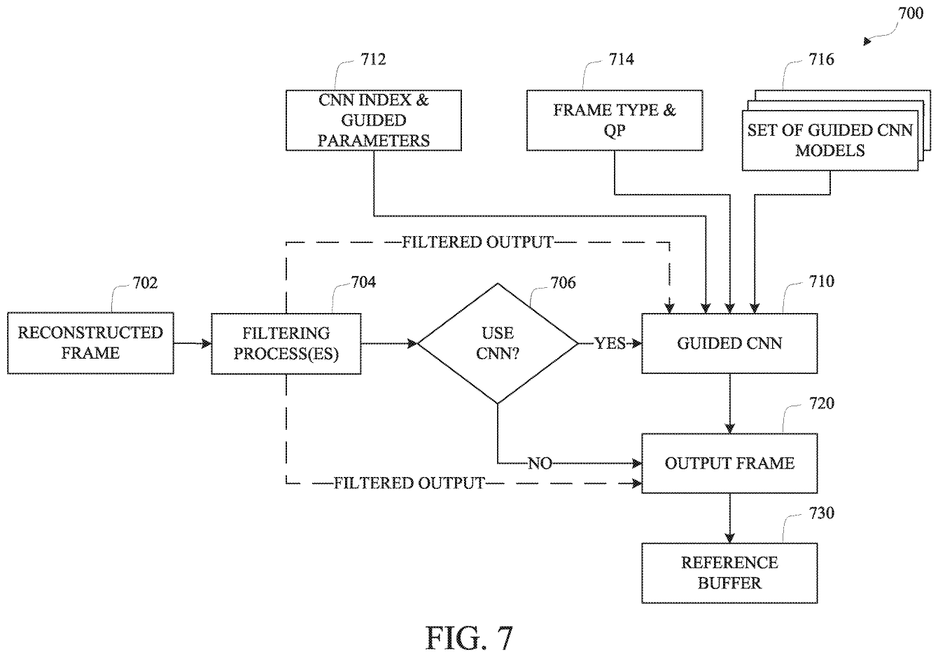

FIG. 7 is a block diagram illustrating an example architecture 700 for using convolutional neural networks to filter a video frame.

A reconstructed frame 702, such as one produced by reconstruction unit 550 or reconstruction unit 470, may be provided or obtained for filtering. Filtering can then be performed by filtering process(es) 704, use CNN 706, and guided CNN 710, which may, for example, be implemented within or correspond to filter unit 560 or filtering unit 480. Filtering process(es) 704 may include one or more filtering processes that are performed before filtering using a CNN. For example, a deblocking filter, constrained directional enhancement filter (CDEF), cross component sample offset (CCSO), switchable loop restoration filter (SLRF), or combinations thereof may be performed at filtering process(es) 704.

Once filtering process(es) 704 is completed, a decision may be made as to whether a CNN filter will be applied to the filtered output from filtering process(es) 704. This decision may be based on information signaled in a compressed bitstream (if performed by a decoder), a decision made by an encoder (if performed by an encoder), inferentially from previous encoding or decoding syntax elements or decisions, or combinations thereof. For example, a syntax element in a compressed bitstream may include a flag indicating whether a CNN filter is to be utilized for a given block, frame, bitstream or certain subset thereof. If a CNN filter is to be used, control passes to guided CNN 710, where a CNN-based filtering process is employed to further filter the filtered output obtained from filtering process(es) 704. If a CNN filter is not to be used, the filtered output from filtering process(es) 704 may bypass the guided CNN 710 and be output directly as output frame 720. Regardless of the path taken, the resulting pixels form an output frame 720, which may be provided for display and/or stored in a reference buffer 730 for use as a reference frame in predicting subsequent video frames.

The CNN-based filtering process may be informed by the CNN index & guided parameters 712, frame type & quantization parameter (QP) 714, and set of guided CNN models 716. The set of guided CNN models 716 include heterogeneously quantized depthwise separable convolutional neural networks (HQDSCNNs) generated according to the search space pruning and quantization techniques described herein. For example, a CNN index, frame type, and QP may be used to select one of the guided CNN models 716 for use by guided CNN 710. The CNN index may be transmitted, for example, on a frame or block basis. For example, in some implementations there may be 36 possible models based on combinations of frame type (intra/inter), QP (for example, based on 6 buckets of QP values), and three possible CNN indices. The guided parameters provided by CNN index & guided parameters 712 may be utilized to configure the selected CNN model.

The CNN index & guided parameters 712 may, for example, be transmitted in the compressed bitstream using a single-level quad tree partitioning. For example, a frame-level unit size may be signaled in a syntax element in the frame header having 4 possible values signaled as a 2-bit unit_index. The maximum unit size may be 2048, 1024, 512 or 256 depending on the frame resolution. In some implementations, the unit_size=max_unit_size>>unit_index. With the single-level quadtree structure, the frame may be first divided into blocks of size unit_size×unit_size. Each unit can be further partitioned once using NONE, HORZ, VERT or SPLIT partition, which may be signaled as a 2-bit partition type for each top level unit. For each leaf-level unit, the guided parameters may be signaled. For example, in some implementations, two weights a0 and a1 are signaled using 4-bits each (16 possible values). For example, this may use a sub-exponential code using previous a0 and a1 as references. A shortcut with 1-bit signaling may also be used to indicate both a0 and a1 are zeroes. In some implementations, configuring the selected CNN model using the guided parameters includes utilizing the weights a0 and a1 to blend the output of the CNN model with the input pixels (e.g., as multipliers in a linear combination) to produce the final filtered block of pixels.

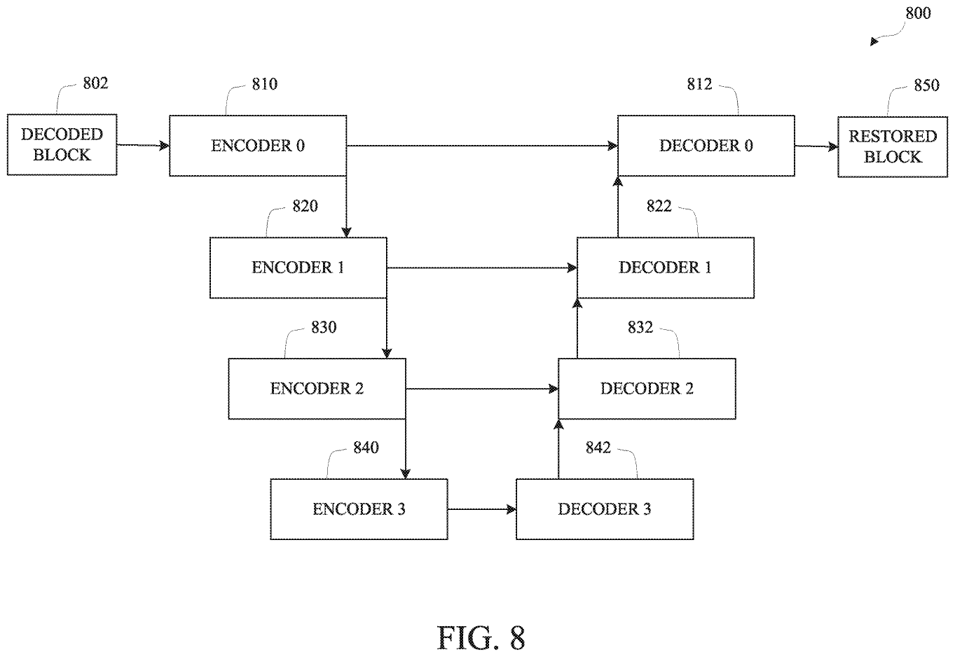

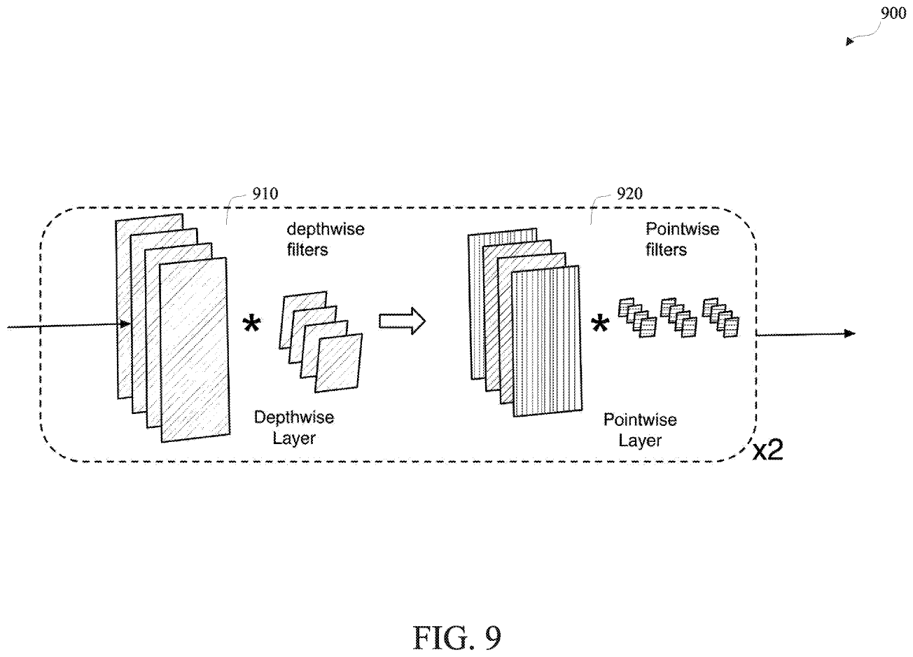

The CNN-based filtering process performed by guided CNN 710 may utilize an architecture based on a U-shaped encoder-decoder convolutional neural network (e.g., a U-Net model architecture). Differences from such an architecture may include, for example, replacing 2D convolutions with depthwise-separable convolutions to reduce computational complexity. For example, a 3×3 convolution with stride s for m input channels and n output channels would be performed in 2 steps. First, depthwise convolution uses m kernels of shape 3×3×1 with stride s to produce m channel intermediate result. Second, pointwise convolution uses n kernels of shape 1×1×m to produce n channel output. For example, an input having one channel may produce an output having two channels. Bottleneck layers may be omitted, so that the model is fully convolutional, allowing an arbitrary input frame size. Downscaling and upscaling may be implicitly handled. For example, a convolution layer (depthwise-separable) with stride 2 may be used to apply convolution and downscaling jointly. Transposed convolution layers may be replaced by depth-to-space (also called pixel shuffle) for upsampling. A depth-to-space operation with block size 2 may be used to apply upscaling. Further description of such depthwise separable convolutional neural network architectures are provided with respect to FIGS. 8 and 9.

FIG. 8 is a block diagram illustrating a depthwise separable convolutional neural network architecture 800. A decoded block 802 is provided to an encoder 0 810. Encoder 0 810 and other components of architecture 800 may be implemented, for example, as described above with respect to FIG. 7 or later with respect to FIG. 9. Encoder 0 810 processes decoded block 802 and produces a downsampled output for the next layer encoder 1 820. Encoder 1 820 performs a similar process and provides a further downsampled output for next layer encoder 2 830. Encoder 2 830 performs a similar process and provides a further downsampled output for next layer encoder 3 840. Encoder 3 840 produces an output to decoder 3 842. In some implementations, passing through each sequential encoder block reduces the resolution of the feature map (e.g., by a factor of 2). Furthermore, while each encoder block (e.g., encoder 0 810, encoder 1 820) operates at a different spatial resolution, they may share an identical internal structural arrangement of convolutional layers (e.g., each containing two depthwise separable convolutional layers).

Decoder 3 842 processes the input from encoder 3 840 and produces an upsampled output to decoder 2 832. Decoder 2 832 processes input from decoder 3 842 and a skip connection from encoder 2 830 and produces an upsampled output for decoder 1 822. Decoder 1 822 processes input from decoder 2 832 and a skip connection from encoder 1 820 and produces an upsampled output for decoder 0 812. Decoder 0 812 processes input from decoder 1 822 and a skip connection from encoder 0 810 and produces a restored block 850. As with the encoder blocks, passing through each sequential decoder block incrementally increases the resolution of the feature map (e.g., by a factor of 2) to reconstruct the spatial dimensions of the restored block 850. The skip connections provide high-resolution spatial features from the encoder blocks directly to the corresponding decoder blocks residing at the same structural level.

Because the different encoder blocks 810, 820, 830, 840 may share an identical internal structural arrangement, and the different decoder blocks 812, 822, 832, 842 may share an identical internal structural arrangement, identically positioned layers across different blocks can be grouped together during the heterogeneous quantization process to reduce the quantization search space. For example, a first depthwise convolutional layer inside encoder 0 810 can be grouped with a first depthwise convolutional layer inside encoder 2 830 such that they are constrained to receive the exact same bit-width allocation (e.g., 10 bits). This constraint allows for a single hardware logic block to be designed and reused for corresponding operations across different levels of the architecture.

FIG. 9 is a block diagram illustrating a block 900 in the depthwise separable convolutional neural network architecture. For example, the encoders and decoders in architecture 800 or used by guided CNN 710 may include two depthwise layers 910 and two pointwise layers 920 (e.g., as indicated by the ‘×2’ multiplier in FIG. 9, representing a first depthwise separable layer followed by a second depthwise separable layer).

Each depthwise and pointwise layer may include parameters including kernel weights, bias weights, and activations. The kernel weights and bias weights represent learned parameters that are stored in memory, while the activations represent the output values (e.g., feature maps) produced by the layer and transmitted as input to the subsequent layer. The weights may be utilized to perform the pointwise and depthwise convolutions, such as described above with respect to guided CNN 710.

During the heterogeneous quantization process, these parameters are evaluated for sensitivity to bit-reduction. For example, the kernel weights of the depthwise layers 910 may be identified as highly sensitive key components, whereas the bias weights and activations may be designated as non-key components. Furthermore, to constrain the search space during quantization, the process may tie the kernel weights and the bias weights for a respective layer 910 or 920 together such that they are evaluated jointly and receive an identical bit allocation.

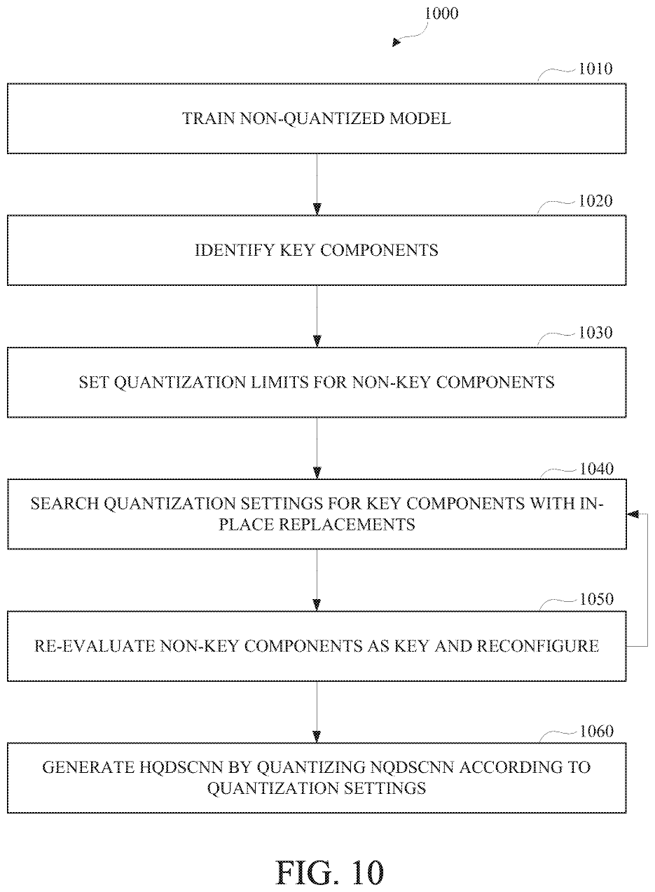

FIG. 10 is a flow diagram of an example technique 1000 for heterogeneously quantizing a depthwise separable convolutional neural network.

As utilized herein, quantization may be performed to produce a fixed point representation including a sign bit, an integer component, and a fractional component. A given fixed point representation may include a total number of bits encompassing the entire representation (total) and a number of integer bits (integer). The number of fractional bits can be determined by subtracting the number of integer bits and the sign bit from the total number of bits.

In some implementations, a floating point parameter may be quantized to a fixed point representation according to the following equation:

$$quantized\_x = 2 \hat{} ( integer - total + 1 ) * clip ( round ( x * 2 \hat{} ( total - integer - 1 ) ) , - 2 \hat{} ( total - 1 ) , 2 \hat{} ( total - 1 ) - 1 )$$

where quantized_x is the quantized representation of parameter or weight x.

At 1010, a non-quantized model is trained, such as one described above with respect to FIGS. 8-9. For example, this may include training a non-quantized depthwise separable convolutional neural network (NQDSCNN). Such a model, for example, may be trained on a corpus of video frames that include examples of artifacts that should be removed and ideal video frames with the artifacts removed. Training hyperparameters (learning rate, number of epochs, and accelerator settings) may be identified along with a baseline performance. The baseline performance may be expressed as a mean squared error (MSE) or similar measure that identifies a minimum desired level of performance. How the minimum level of performance is defined and whether it is met or exceeded may vary depending on the measure utilized. For example, for some measures, like MSE, the minimum desired level of performance may be met if the MSE is equal to or less than the minimum desired level of performance. For other measures of performance, the determination may be different (e.g., the minimum level of performance may be met if the measure is equal to or greater than the minimum desired level of performance).

At 1020, key components are identified by identifying key components of the NQDSCNN. A key component is determined based on its relative importance to the overall performance of the NQDSCNN. For example, layer-by-layer testing or parameter-type by parameter-type (e.g., pointwise, depthwise, kernel weights, bias weights, activations, etc.) may be done to identify the relative impact on performance of certain layers by quantizing one layer or parameter at a time to a test bit-width (e.g., a 16-bit fixed point representation), running an inference using the NQDSCNN with the respective component quantized to the test bit-width (i.e., using post-training quantization), and then examining the resulting level of performance. For example, examining the resulting level of performance may include determining whether a mean squared error (MSE) associated with the inference falls within a threshold percentage of a baseline MSE (e.g., by comparing a mean squared error (MSE) associated with the quantized layer to a baseline MSE of the NQDSCNN to determine if a variance falls within a threshold, such as within 5% of the baseline MSE). The components identified as likely being more important to the performance of the model are marked as key components. For example, it may be determined that kernel weights of the depthwise separable convolutional layers have the highest impact on performance, and thus the kernel weights are designated as the key components.

At 1030, quantization limits are set for non-key components. This includes setting quantization settings for non-key components of the NQDSCNN. For example, a maximum level of quantization may be identified which may be utilized for the non-key components. In some implementations that level may be set by allocating 10 bits for non-key components. Different maximum levels of quantization may be set by testing successively lower bit allocations and evaluating the corresponding level of performance.

At 1040, quantization settings are searched for key components with in-place replacements by evaluating quantization settings for key components of the NQDSCNN. In order to manage the complexity of the search, constraints may be utilized to constrain the search space. For example, all identical components may receive the same bit allocation, where two components are defined identical if they are positioned similarly in the depthwise separable convolution neural network (DSCNN) structure, e.g., weights of the second convolutional layers in all encoders (e.g., by grouping a depthwise layer of a first encoder block with a corresponding identically-positioned depthwise layer of a second encoder block). Identically positioned layers within decoder blocks may also be grouped. Additionally, kernel weights and bias weights may be allocated the same number of bits for a given parameter. This allows grouping a subset of key components and also facilitates consistent hardware implementation for similar components. Total bits allocated to a component may be constrained to a multiple of 2 and an approximate geometric sequence. A 32-bit floating number has 23 bits for mantissa. The fixed-point search space is then limited to 10 to 24 (avoiding odd allocations) bits {10, 12, 14, 16, 20, 22, 24}.

Groups of components may be iteratively quantized at different settings within the available search space and in-place replaced in the model using post-training quantization to enable iterative testing of the model within the search space. The resulting level of performance for each test may be recorded to permit correlation across the tests to determine which combinations of bit allocations provide a desirable bit allocation to corresponding level of performance tradeoff. A tentative selection of bit allocations may be made before proceeding to the next step. To find the best integer allocation for a given parameter, the distribution of outputs from the baseline floating point model may also be used as a reference point. For example, the heterogeneous quantization process may include analyzing a distribution of outputs from a baseline floating point representation of the NQDSCNN to determine an allocation for an integer number of bits for a respective component of the HQDSCNN.

At 1050, non-key components are reevaluated as key and bit allocations are reconfigured, which may be made in view of a tentative selection of bit allocations. In other words, 1050 involves re-evaluating non-key components of the NQDSCNN for reclassification as key. For example, a determination may be made as to whether the level of performance meets a target performance metric. For example, the target performance metric may include a comparison of baseline MSE of the NQDSCNN with MSE of levels of the NQDSCNN. If target performance metric is not met, one or more non-key components may be upgraded to a key-component and bit allocations for those component(s) may be (iteratively) increased until performance meets the baseline performance requirements.

Once performance meets the baseline performance requirements, the resulting number of bits used for the model is evaluated to determine whether the hardware complexity (e.g., surface area, number of gates, etc.) falls within a desired complexity. For example, a determination may be made as to whether the hardware complexity meets a target hardware complexity. For example, the target hardware complexity may include a ceiling logic gate count, such as 700k gates. If not, one or more non-key components may be upgraded to a key-component and bit allocations for those component(s) may be (iteratively) increased while reducing the bit allocations for existing key components. Bit allocations may instead be reduced or key-components downgraded to non-key components. The resulting level of performance may be rechecked and the process may be iteratively performed until both performance and hardware complexity requirements are satisfied or a determination is made that the requirements should be adjusted.

At 1060, the HQDSCNN is generated by quantizing the NQDSCNN according to the quantization settings to produce a heterogeneously quantized depthwise separable convolutional neural network (HQDSCNN).

An example output HQDSCNN from technique 1000 is now described. This output is described using the following naming conventions. Each encoder and decoder block is assigned with an index from 0 to N, with higher numbers representing layers closer to the middle of the “U” shape. The convention encoder(decoder)_convX is used to represent this, where X is the block index. A given encoder/decoder may have two separable (depthwise and pointwise) convolution layers. These are described as encoder(decoder)_convX_Y where Y is the 0 or 1 indicating the first or second convolution layer. Depthwise and pointwise layers are distinguished as encoder(decoder)_convX_Y_depthwise and encoder(decoder)_convX_Y_pointwise. Using the foregoing conventions, follows is an example quantization schema produced using technique 1000:

| Layer Name | Total Bits | Integer Bits |
|---|---|---|
| encoder_conv0_0_depthwise_weights | 10 | 2 |
| encoder_conv0_0_depthwise_activation | 14 | 6 |
| encoder_conv0_0_pointwise_weights | 16 | 4 |
| encoder_conv0_0_pointwise_activation | 10 | 3 |
| encoder_conv0_1_depthwise_weights | 10 | 2 |
| encoder_conv0_1_depthwise_activation | 14 | 6 |
| encoder_conv0_1_pointwise_weights | 10 | 4 |
| encoder_conv0_1_pointwise_activation | 10 | 3 |
| encoder_conv1_0_depthwise_weights | 10 | 2 |
| encoder_conv1_0_depthwise_activation | 10 | 4 |
| encoder_conv1_0_pointwise_weights | 16 | 4 |
| encoder_conv1_0_pointwise_activation | 10 | 2 |
| encoder_conv1_1_depthwise_weights | 10 | 2 |
| encoder_conv1_1_depthwise_activation | 10 | 4 |
| encoder_conv1_1_pointwise_weights | 10 | 4 |
| encoder_conv1_1_pointwise_activation | 10 | 2 |
| encoder_conv2_0_depthwise_weights | 10 | 2 |
| encoder_conv2_0_depthwise_activation | 14 | 6 |
| encoder_conv2_0_pointwise_weights | 16 | 4 |
| encoder_conv2_0_pointwise_activation | 10 | 1 |
| encoder_conv2_1_depthwise_weights | 10 | 2 |
| encoder_conv2_1_depthwise_activation | 14 | 6 |
| encoder_conv2_1_pointwise_weights | 10 | 4 |
| encoder_conv2_1_pointwise_activation | 10 | 1 |
| encoder_conv3_0_depthwise_weights | 10 | 2 |
| encoder_conv3_0_depthwise_activation | 14 | 6 |
| encoder_conv3_0_pointwise_weights | 16 | 4 |
| encoder_conv3_0_pointwise_activation | 10 | 1 |
| encoder_conv3_1_depthwise_weights | 10 | 2 |
| encoder_conv3_1_depthwise_activation | 14 | 6 |
| encoder_conv3_1_pointwise_weights | 10 | 4 |
| encoder_conv3_1_pointwise_activation | 10 | 1 |
| decoder_conv3_0_depthwise_weights | 10 | 2 |
| decoder_conv3_0_depthwise_activation | 10 | 4 |
| decoder_conv3_0_pointwise_weights | 10 | 4 |
| decoder_conv3_0_pointwise_activation | 10 | 1 |
| decoder_conv3_1_depthwise_weights | 10 | 2 |
| decoder_conv3_1_depthwise_activation | 10 | 4 |
| decoder_conv3_1_pointwise_weights | 10 | 4 |
| decoder_conv3_1_pointwise_activation | 10 | 1 |
| decoder_conv2_0_depthwise_weights | 10 | 2 |
| decoder_conv2_0_depthwise_activation | 10 | 4 |
| decoder_conv2_0_pointwise_weights | 10 | 4 |
| decoder_conv2_0_pointwise_activation | 10 | 1 |
| decoder_conv2_1_depthwise_weights | 10 | 2 |
| decoder_conv2_1_depthwise_activation | 10 | 4 |
| decoder_conv2_1_pointwise_weights | 10 | 4 |
| decoder_conv2_1_pointwise_activation | 10 | 1 |
| decoder_conv1_0_depthwise_weights | 10 | 2 |
| decoder_conv1_0_depthwise_activation | 10 | 4 |
| decoder_conv1_0_pointwise_weights | 10 | 4 |
| decoder_conv1_0_pointwise_activation | 10 | 3 |
| decoder_conv1_1_depthwise_weights | 10 | 2 |
| decoder_conv1_1_depthwise_activation | 10 | 4 |
| decoder_conv1_1_pointwise_weights | 10 | 4 |
| decoder_conv1_1_pointwise_activation | 10 | 2 |
| decoder_conv0_0_depthwise_weights | 10 | 2 |
| decoder_conv0_0_depthwise_activation | 14 | 6 |
| decoder_conv0_0_pointwise_weights | 10 | 4 |
| decoder_conv0_0_pointwise_activation | 10 | 2 |
| decoder_conv0_1_depthwise_weights | 10 | 2 |
| decoder_conv0_1_depthwise_activation | 14 | 6 |
| decoder_conv0_1_pointwise_weights | 10 | 4 |
| decoder_conv0_1_pointwise_activation | 10 | 3 |
| conv_out_depthwise_weights | 10 | 2 |
| conv_out_depthwise_activation | 10 | 4 |
| conv_out_pointwise_weights | 10 | 4 |

With the above example schema, a heterogeneously quantized depthwise separable convolutional neural network (HQDSCNN) may be implemented using a magnitude of approximately 700,000 logic gates while limiting peak signal to noise ratio (PSNR) loss as compared to a comparable non-quantized model of 0.07 PSNR.

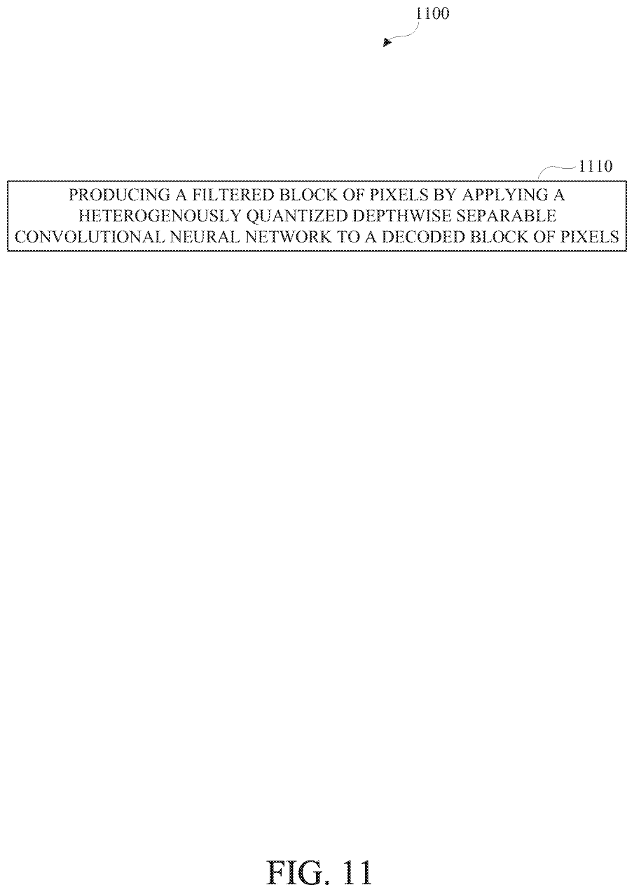

FIG. 11 is a flow diagram of an example technique 1100 for filtering pixels using a heterogeneously quantized depthwise separable convolutional neural network (HQDSCNN).

Step 1110 includes producing a filtered block of pixels by applying a heterogeneously quantized depthwise separable convolutional neural network (HQDSCNN) to a decoded block of pixels. The HQDSCNN may include layers having components represented using a respective number of bits pre-determined according to a heterogeneous quantization process, such as described above with respect to technique 1000 and FIG. 10. The heterogeneous quantization process used to determine the HQDSCNN may include identifying a set of key components, setting a minimum number of bits for representing non-key components, and iteratively evaluating candidate numbers of bits for representing components of the set of key components.

The components of the HQDSCNN may include depthwise and pointwise kernel weights, bias weights, and activation outputs for each of the plurality of layers. In some implementations, each component is represented by a fixed point representation according to a respective total number of bits and a respective integer number of bits allocated to that component. In some implementations, the heterogeneous quantization process used to determine the HQDSCNN further includes training a non-quantized depthwise separable convolutional neural network (NQDSCNN) and quantizing the NQDSCNN according to the respective number of bits for each component of the NQDSCNN to produce the HQDSCNN. Iteratively evaluating candidate numbers of bits for representing components of the set of key components may exclude odd numbers, numbers greater than 24, and numbers less than 10, and may constrain candidate bit allocations to an approximate geometric sequence of even numbers (e.g., 10, 12, 14, 16, 20, 22 and 24). Furthermore, the HQDSCNN may be structurally constrained such that identical components grouped across different encoder blocks or different decoder blocks receive an identical bit allocation, and kernel weights and bias weights for a given layer receive an identical bit allocation.

The HQDSCNN may include layers having components represented using a respective number of bits according to the example table described above with respect to FIG. 10.

In some implementations, prior to or as part of producing the filtered block of pixels, technique 1100 may include receiving at least one syntax element indicating a convolutional neural network (CNN) index, identifying a frame type and a quantization parameter (QP) associated with the decoded block of pixels, and selecting the HQDSCNN from a set of guided CNN models based on a combination of the CNN index, the frame type, and the QP. Furthermore, technique 1100 may include partitioning a frame comprising the decoded block of pixels into a plurality of units using a single-level quadtree structure, receiving guided parameters for a respective leaf-level unit of the quadtree structure, and configuring the selected HQDSCNN using the guided parameters.

Step 1110 may, for example, be performed by guided CNN 710 in the context of FIG. 7. In this context, the referenced HQDSCNN may be one of the set of guided CNN models 716.

Techniques 1000 and 1100 may vary depending on the implementation. For example, steps may be omitted, added, combined, modified, or combinations thereof. For example, techniques 1000 or 1100 may be modified to include steps or aspects described elsewhere in this disclosure. Techniques 1000 and 1100 may be implemented in a non-transitory computer readable medium, such as the memory 110 shown in FIG. 1, by storing instructions on the non-transitory computer readable medium, that when executed by a processor, such as the processor 120 shown in FIG. 1, cause the processor to perform or cause performance of the steps of the technique.

Technique 1100 may be implemented in a video encoding apparatus, such as encoder 400 shown in FIG. 4, or a video decoding apparatus, such as the decoder 500 shown in FIG. 5. The decoded block filtered by technique 1100 may be obtained from an encoded bitstream, such as the compressed bitstream 502, and applying technique 1100 (e.g., by the filtering unit 560 of FIG. 5) may be required in order to properly decode the encoded bitstream. Accordingly, such a bitstream may include bits decodable using technique 1100. Technique 1100 may be used in the restoration loop of an encoder (e.g., by the filtering unit 480 of FIG. 4) and thus a bitstream may be encoded using technique 1100.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, F for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible non-transitory computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
producing a filtered block of pixels by applying a heterogeneously quantized depthwise separable convolutional neural network (HQDSCNN) to a decoded block of pixels,
wherein the HQDSCNN includes a plurality of layers each having components represented using a respective number of bits pre-determined according to a heterogeneous quantization process including identifying a set of key components, setting a minimum number of bits for representing non-key components, and iteratively evaluating candidate numbers of bits for representing components of the set of key components.

2. The method of claim 1, wherein the components of the HQDSCNN include depthwise and pointwise kernel weights, bias weights, and activation outputs for each of the plurality of layers.

3. The method of claim 1, wherein each component is represented by a fixed point representation according to a respective total number of bits and a respective integer number of bits allocated to that component.

4. The method of claim 1, wherein the heterogeneous quantization process further includes training a non-quantized depthwise separable convolutional neural network (NQDSCNN) and quantizing the NQDSCNN according to the respective number of bits for each component of the NQDSCNN to produce the HQDSCNN.

5. The method of claim 4, wherein the heterogeneous quantization process further includes iteratively evaluating the number of bits based on a target hardware complexity, wherein the target hardware complexity includes a ceiling logic gate count.

6. The method of claim 4, wherein the heterogeneous quantization process further includes analyzing a distribution of outputs from a baseline floating point representation of the NQDSCNN to determine an allocation for an integer number of bits for a respective component of the HQDSCNN.

7. The method of claim 1, wherein iteratively evaluating candidate numbers of bits for representing components of the set of key components excludes odd numbers, numbers greater than 24, and numbers less than 10.

8. The method of claim 1, wherein identifying the set of key components comprises:
quantizing a respective component of a non-quantized depthwise separable convolutional neural network (NQDSCNN) to a test bit-width comprising a 16-bit fixed point representation;
running an inference using the NQDSCNN with the respective component quantized to the test bit-width; and
determining whether a mean squared error (MSE) associated with the inference falls within a threshold percentage of a baseline MSE.

9. The method of claim 8, wherein the threshold percentage is 5%.

10. The method of claim 1, wherein identifying the set of key components comprises identifying kernel weights of depthwise separable convolutional layers of the HQDSCNN as the set of key components, and designating bias weights and activation outputs as non-key components.

11. The method of claim 1, wherein evaluating quantization settings for the key components comprises:
grouping a subset of the key components that are positioned identically across different encoder blocks or different decoder blocks of a non-quantized depthwise separable convolutional neural network (NQDSCNN); and
constraining the quantization settings such that identical components in the subset receive an identical bit allocation.

12. The method of claim 1, wherein evaluating quantization settings for the key components comprises constraining the quantization settings such that kernel weights and bias weights for a layer receive an identical bit allocation.

13. The method of claim 1, wherein evaluating quantization settings for the key components comprises constraining candidate bit allocations to an approximate geometric sequence of even numbers comprising 10, 12, 14, 16, 20, 22 and 24.

14. The method of claim 1, further comprising:
receiving at least one syntax element indicating a convolutional neural network (CNN) index;
identifying a frame type and a quantization parameter (QP) associated with the decoded block of pixels; and
selecting the HQDSCNN from a set of guided CNN models based on the CNN index, the frame type, and the QP.

15. The method of claim 14, further comprising:
partitioning a frame comprising the decoded block of pixels into a plurality of units using a single-level quadtree structure;
receiving guided parameters for a respective leaf-level unit of the quadtree structure; and
configuring the selected HQDSCNN using the guided parameters.

16. A decoding apparatus comprising:
at least one processor configured to:
produce a filtered block of pixels by applying a heterogeneously quantized depthwise separable convolutional neural network (HQDSCNN) to a decoded block of pixels,
wherein the HQDSCNN includes a plurality of layers each having components represented using a respective number of bits pre-determined according to a heterogeneous quantization process including identifying a set of key components, setting a minimum number of bits for representing non-key components, and iteratively evaluating candidate numbers of bits for representing components of the set of key components.

17. The decoding apparatus of claim 16, wherein the components of the HQDSCNN include depthwise and pointwise kernel weights, bias weights, and activation outputs for each of the plurality of layers.

18. A non-transitory computer-readable storage medium storing an encoded bitstream comprising video data, wherein the encoded bitstream is decodable by a decoding apparatus by performing operations comprising:
producing a decoded block of pixels from the video data; and
producing a filtered block of pixels by applying a heterogeneously quantized depthwise separable convolutional neural network (HQDSCNN) to the decoded block of pixels,
wherein the HQDSCNN includes a plurality of layers each having components represented using a respective number of bits pre-determined according to a heterogeneous quantization process including identifying a set of key components, setting a minimum number of bits for representing non-key components, and iteratively evaluating candidate numbers of bits for representing components of the set of key components.

19. The non-transitory computer-readable storage medium of claim 18, wherein the encoded bitstream further comprises at least one syntax element indicating a convolutional neural network (CNN) index, and wherein the decoding apparatus selects the HQDSCNN based on the CNN index.

20. The non-transitory computer-readable storage medium of claim 19, wherein the at least one syntax element further indicates guided parameters for configuring the selected HQDSCNN.
